(19) United States
(12) Patent Application Publication
(10) Pub. No.: US 2013/0238519 A1
(43) Pub. Date: Sep. 12, 2013

(54) SYSTEM AND METHOD FOR PROVIDING A COLLEGE FAIR WEBINAR FOR EFFECTIVE COMMUNICATION BETWEEN AN ENTITY AND A USER

(71) Applicants: John W. Hall, Dove Canyon, CA (US); Michael A. Krahelski, Irvine, CA (US)

(72) Inventors: John W. Hall, Dove Canyon, CA (US); Michael A. Krahelski, Irvine, CA (US)

(21) Appl. No.: 13/789,377

(22) Filed: Mar. 7, 2013

Related U.S. Application Data
(60) Provisional application No. 61/607,839, filed on Mar. 7, 2012.
(60) Provisional application No. 61/694,607, filed on Aug. 29, 2012.

(51) Int. Cl. G06Q 10/00

(52) U.S. Cl. CPC G06Q 10/00; G06Q 50/205
USPC 705/326

(57) ABSTRACT

Embodiments of a system and method are disclosed for providing effective communication between an entity, e.g., college, and users, e.g., prospective students, parents, relatives, guardians, counselors, etc. Embodiments provide a campaign management tool designed to meet the needs of the school admissions officers and other school personnel. An embodiment of the campaign management tool allows a school to create and manage webinar session campaigns to reach prospective students and to convince students offered admission to enroll. Embodiments of the system and method allow a school to create and manage webinar, email, mail and telephone campaigns using the campaign management tool. Embodiments allow a high school/district to utilize a college fair webinar. Embodiments provide unique widgets to be used on the school websites or other websites. The widget provides visitor search engine analytics and allows the students to register for webinars and introduce themselves well before the application process begins.

This application claims benefit of priority from U.S. Provisional Application No. 61/607,839, filed Mar. 7, 2012, and U.S. Provisional Application No. 61/694,607, filed Aug. 29, 2012. Both of these provisional patent applications are hereby incorporated by reference herein.

### FIELD OF THE INVENTION

The technical field is related to computer-based communication between an entity and one or more users. More specifically, the technical field relates to communication between individuals and educational institutions.

### BACKGROUND OF THE INVENTION

College recruitment methods have changed very little over the last fifty years. Even with the increased use of the internet, colleges still spend significant portions of their recruiting budgets on printed materials for use as mailers or at traditional college fairs (which are still done annually on high school, school district and regional levels). These fairs involve face-to-face meetings between college representatives and high school students interested in going to college. The colleges sometimes send employees to host the fairs or booths at the fairs, but more often get local volunteers from their alumni associations for high school and district fairs. Regional fairs, at local hotels or convention centers, will usually be staffed by paid personnel from the colleges. The drawback of most of these fairs is that they are limited to one night, for high school and district fairs, or one weekend, for regional fairs, each year. If the student misses that annual opportunity, there are no real alternatives for the same experience. The schools also miss the opportunity to speak to the particular students.

Colleges have struggled to find new ways to connect with prospective students. Though schools still spend large sums on print and other materials, the effectiveness of such marketing is suspect. College fairs still account for much of the face-to-face recruiting done by schools. However, over the last few years, there has been a significant reduction in the number of schools participating. Budget constraints have clearly contributed to the decline in college participation; however, when you look at the amount that a large school still spends on advertising and print handouts, it is clear that reduced participation in fairs is also an acknowledgment that such events are no longer an effective means to reach the right students. A significant drawback of the traditional fairs is that the students and schools can do little or no pre-qualification, thereby causing school representatives to spend as much time with students who have no chance of admission as they do with students who would be a perfect fit for their schools. Finally, college admissions personnel have not had any viable alternatives to replace the current paper and labor-intensive processes used today.

Every year, more than 400,000 students attend local, regional and national college fairs seeking information about colleges, universities and other postsecondary institutions. They also try to find the “right school” by buying books and doing on-line searches. This is just 5% of the approximately 8 million high school juniors and seniors in the United States (2000 US census). The percentage of students who enroll in a college or a trade school within 12 months of graduating high school has climbed steadily from 47% in 1973 to 67% in 2007, with those pursuing associate's or bachelor's degrees increasing the fastest (US Department of Education; USA Today Mar. 16, 2010). However, even with the numbers growing, the opportunity for effective communication is actually declining.

Most students select schools based on input from friends, family, coaches, teachers and counselors. While this input is extremely valuable, it is limited and normally does not involve speaking to those already attending these colleges or to school representatives; also, it may miss a possible “perfect fit” college that the student should consider in his or her review of colleges. There are over 4,000 (universities, colleges and specialty schools) within the United States.

Universities, colleges, and specialty schools are trying to connect with students, through traditional fairs, direct mail campaigns, advertisements on-line and in other media, and other means. However, for the most part, these methods do not involve direct dialogue. In today's economic climate with diminished travel budgets, especially for state schools, which charge increased fees for out-of-state students and are actively trying to grow that portion of their student populations, the opportunity to touch students outside of a school's traditional market area is becoming even more difficult.

### SUMMARY OF THE INVENTION

The present invention is directed to a method for providing effective communication between an entity and one or more users. The method comprises: managing one or more webinars by allowing a user to register for a webinar offered by the entity, wherein the user is a prospective student, parent, relative, guardian, counselor or other person associated the student; obtaining profile information of a student when the user registers for the webinar; sending the profile information of the student to the entity when the user registers for the webinar offered by the entity, wherein the entity is a college, high school, high school district or other educational organization; displaying the profile information of the student during the webinar together with questions posted by the user; and allowing a facilitator to control answering of questions in the webinar. The present invention is also directed to a system corresponding to the above method.

The present invention is also directed to a method for providing effective communication between a high school, high school district or other education organization; one or more colleges and/or specialty schools; and one or more users, comprising: registering one or more colleges and/or specialty schools to participate in an on-line college fair/visit webinar conducted by the high school, high school district or other education organization; registering one or more users to participate in the webinar, wherein the one or more users is selected from the group consisting of prospective students, parents, relatives, guardians, counselors and other people associated with the students; allowing each of the colleges and/or specialty schools to present information about its school to the one or more users in the webinar; and allowing the one or more users to submit questions to any of the colleges and/or specialty schools in the webinar, wherein the questions and answers from the colleges and/or specialty schools are viewable online by one or more participants in the webinar. The present invention is also directed to a system corresponding to the above college fair/visit webinar method.

The present invention is further directed to a campaign management system and/or widgets, either of which are intended to be preferably employed in any of the above systems and methods. A campaign management system, implemented using a computing device, for recruiting prospective students for admission to a college or specialty school, wherein the computing device comprises memory and one or more processors adapted for setting up and executing webinars between school officials representative of the college or specialty school and users, wherein the users include prospective students and/or other people associated with the prospective students. One or processors are also employed to filter prospective student profile information for targeting desirable prospective students for admission to the college or specialty school, and managing contacts with the users, and scheduling sessions between the users and the college or specialty school. The managing of contacts and scheduling of sessions comprise utilizing an integrated system incorporating webinars, email, mail, telephone, and/or video calling to reach the users participating in the webinars. The present invention is also directed to a system corresponding to the above method.

### BRIEF DESCRIPTION OF THE DRAWINGS

The detailed description will refer to the following drawings, wherein like numerals refer to like elements, and wherein:

FIG. 1 illustrates an exemplary process flow of an embodiment of a method and system for providing effective two-way communication between an entity and prospective students.

FIG. 2 illustrates exemplary hardware components of a computer that may be used in connection with an embodiment of a system and method for providing effective communication between an entity and one or more users.

FIG. 3 depicts an exemplary webinar user interface screen illustrating screen features in use during an exemplary webinar chat session. Highlights of exemplary chat session features (numbered 1-10) as further described below.

FIG. 4 depicts an exemplary webinar user interface screen illustrating screen features in use during a private chat during an exemplary webinar chat session.

FIG. 5 illustrates an exemplary screenshot from the College Fair application.

FIGS. 6A-6E illustrate exemplary screenshots from the College Fair application and from a webinar session, including pages for school officials to set up and manage a College Fair, webinar or recruitment campaign, pages for managing a user's College Fair and/or webinar scheduling and participation and pages for setting up a profile.

FIG. 7 illustrates an exemplary process flow of an embodiment of a method and system for providing features of a campaign management system.

FIG. 8 illustrates an exemplary screenshot of a campaign management tool for the campaign management system.

FIG. 9 illustrates an exemplary screenshot of a user interface screen for student users to input their profile information.

FIG. 10 illustrates an exemplary screenshot of a user interface screen for creating and customizing a website widget.

FIG. 11 illustrates an exemplary screenshot of a college fair widget.

FIGS. 12A and 12B illustrate exemplary hardware components including, inter alia, video communications flow processes utilized by the systems and methods of the present invention.

FIG. 13 illustrates an exemplary process flow of an embodiment of a method and system for providing effective two-way communication between an entity and user.

### DETAILED DESCRIPTION OF THE PREFERRED EMBODIMENTS

It is to be understood that the figures and descriptions of the present invention may have been simplified to illustrate elements that are relevant for a clear understanding of the present invention, while eliminating, for purposes of clarity, other elements found in a typical system or method for providing computer-based communication, typical webinar system, or typical method for providing a webinar system. Those of ordinary skill in the art will recognize that other elements may be desirable and/or required in order to implement the present invention. However, because such elements are well known in the art, and because they do not facilitate a better understanding of the present invention, a discussion of such elements is not provided herein. It is also to be understood that the drawings included herewith only provide diagrammatic representations of the presently preferred structures of the present invention and that structures falling within the scope of the present invention may include structures different than those shown in the drawings. Reference will now be made to the drawings wherein like structures are provided with like reference designations.

The term “avatar”, as mentioned throughout this disclosure for any of the embodiments, may be a photograph of a person or any other item, icon, or image used to represent the person.

The term “school”, as mentioned throughout this disclosure for any of the embodiments, comprises high school, high school district, college, specialty school, post-graduate school, education facility, education entity, or any person(s) or entity(ies) representing any of the these facilities/entities.

Embodiments of a system and method are disclosed for providing effective communication between an entity, e.g., college, high school, or high school district, and one or more users (e.g., prospective candidate, student, parent, relative, guardian, counselor, or other person associated with the prospective candidate or student, etc.).

Embodiments of the system and method provide prospective students the ability to communicate with school admissions personnel, other college personnel, current students and others with the same school interests, thus providing an effective tool for high school students and other users looking to make a college or other post-secondary education choice.

Embodiments of the system and method provide a web application with two distinct environments, e.g., one for the subscriber base (colleges, specialty schools, and more specifically, admissions and other departments) and the other for the users (user community) (students, parents, relatives, guardians, counselors, etc.). The web application further includes an integrated campaign management tool for facilitating and managing webinars, email, mail and telephone campaigns with the same flexibility and oversight in support of the admission process or other school function, including selection of prospective candidates for possible admission to a school by admissions officials.

Students ultimately pick where they will attend college based on a number of factors, including the relationship that the student and his/her family feel for a school. Students are more likely to choose a school with which they have a relationship. One of the best ways to cultivate that relationship is by making personal contact with the student an easy and on-going process throughout their entire search process. Embodiments of the system and method provide a way to manage these relationships (especially as schools have reduced budgets and staffing), during the entire admissions process, from inquiry, to application to ultimate enrollment.

Embodiments of the system and method provide a campaign management tool designed to meet the needs of the school admissions officers and other officials. An embodiment of the campaign management tool allows a school to create and manage webinar session campaigns to reach prospective applicants and to convince students offered admission to enroll. Sessions may be large public group presentations, with video and webcam capabilities, or smaller public or “by invitation only” dialogues where the students may ask questions of school personnel.

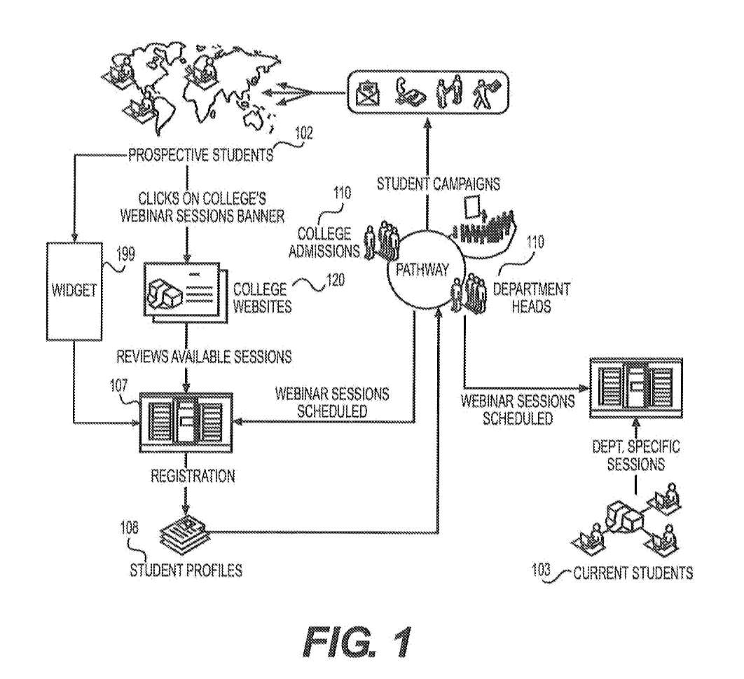

Accordingly, as illustrated in FIG. 1, the present application provides a system and method for effective communication between an entity 110, such as a college or specialty school, and users, including prospective candidates/students 102, parents, relatives, guardians and/or counselors. In one aspect, the system and method allows a user to register 107 for a given webinar offered by the entity. In the course of registering for the webinar, the user may choose a unique avatar characteristic of the user, which may incorporate one or more features, such as the user's picture, screen name etc. In conjunction with registering for the webinar, a user submits a profile 108. For a prospective student candidate, the profile includes an academic profile for evaluation by school admissions officials. The profile information 108 may be provided by the prospective candidate or by another person associated with the candidate, such as a parent, relative, guardian, school counselor etc. The profile information is preferably obtained prior to the webinar, and may be obtained when registering for the webinar, at some point prior to the webinar or even after the webinar.

Profile information of the candidate may be displayed during the webinar together with questions posted by the student, candidate or the person associated with the candidate. In some cases, a school admission official may assign a candidate to one or more saved lists, based on, for example, the dialogue between the user and school admission official, or the profile information of the candidate and/or other information pertaining to the candidate obtained before, during or after the webinar. In some embodiments, the lists may be displayed on the screen in association with the candidate's avatar.

Embodiments of the system and method provide for the creation of one or more unique widgets 199 on a school's website 120 or other website. Participants may schedule their participation in a webinar as a result of registering for the webinar after clicking one or more widgets 199 on a school's website. By clicking on a widget 199, for example, a prospective student candidate, parent or counselor is directed to a page offering the means to register to one or more webinars offered by the school. Alternatively, clicking on a widget may provide direct registration to the one or more webinars offered by the school (i.e., without being required to go to another page). The widget gives a school the ability to advertise their webinars.

The widget provides visitor search engine analytics and allows the students to introduce themselves well before the application process begins. Research shows that 30% of applicants to a school are completely unknown to that school prior to the receipt of the application itself. The widget encourages students, parents and counselors to register for the product by showing them the available public webinar sessions and thus attracting them with the opportunity to speak personally with college personnel and students and thereby get their profiles seen during the otherwise impersonal and automated college admissions process. The widget may be integrated to a website offered in accordance with an embodiment of the system and method and/or, on the main system site. In either scenario, the widget will preferably show available sessions for colleges.

Once registered, a user may participate in webinars offered by different colleges or schools and may choose to share their profile information with those schools that they “like” or with any school that is interested in students with their profile characteristics (this is especially attractive to smaller schools that fall under the normal college search radar). The webinar session may be shown in real-time or it may be available for re-broadcast at a later time. The webinar may include one or more presentations from one or more school officials. The presentations may be in real-time or they may be pre-recorded.

The system and method further allows participants in the webinar to engage in a Group Chat in which dialogue from the participants is displayed in one or more webcams, video streams and/or audio streams. In other embodiments, the system and method allows candidates or other users in a webinar session to engage in a Private Chat where users may submit and view questions and answers via one or more chat, video and/or audio streams that are not displayed to other candidates participating in the webinar session.

In a further aspect, the college, admissions official or facilitator may manage or control the answering of questions by a user. For example, a facilitator may control the answering of questions based on number of questions per users, and/or number of questions available for all users in a session. This feature may be turned on or off and reset during a session. For example, a moderator may accept the next 20 questions from the participants, answer those, and accept another 20 or more or less questions. Moreover, the chat may be unlimited entries from users, or may be limited to one or more questions from each user. The methods and systems may allow users to submit Group Questions and/or Private Questions, and view answers thereto, in one or more chat, video and/or audio streams, wherein the Group Questions and Private Questions, and answers thereto, may be viewed by one or more participants participating in the session or by one or more users viewing the webinar thereafter. The questions may be viewed in real-time or may remain visible for viewing at a later time during or after the session. Users may be permitted to submit Private questions while the Group Chat or Group Questions are taking place. In addition, the methods and systems may allow the facilitator to control the number of questions submitted (e.g., no more than 5, 10, 15, 20 etc.), including the number of questions per student (e.g., no more than 1, 2, 3, 4 etc.). Certain common questions may be quickly addressed with predefined answers.

In some cases, the facilitator may block a participant from accessing a webinar or participating in Group Chat, Private Chat and/or Questions. Questions may be easily identified and viewed by any number of participants in the session. The questions and answers may be viewed in real-time and/or they may be remain visible or be available for viewing at a later time during or after the session. When viewing the screen during a webinar or when using the campaign management tool, the methods and systems may allow an entity to view or display profile information from a prospective candidate by clicking a candidate's avatar. Students previously assigned to a college's list or listed will be displayed with a special icon when they participate in future sessions.

The system and method allows a school official to extend any given webinar, when necessary or appropriate. In addition, the system and method further includes a feature, allowing the school to invite or pull a student aside directly for a private one-on-one meeting before, during, or after the webinar session, or to schedule one at another time so as to provide a further opportunity for questions to be answered by school officials or student representatives in another webinar or video stream. Sessions may be scheduled as Public, and be open to all students, or Private, in which the school prompts or invites a candidate to engage in a private online meeting or schedules a meeting or phone conference at another time requiring the student to respond to an invitation from the school. In some cases, a school official may invite a user to a different session, online meeting, telephone conversation, video call/meeting, or in-person meeting based on, for example, the profile information of the candidate associated with the user, or the dialogue between the school official and the user. Private one-on-one sessions may involve two-way chat or two-way video chat.

The system and method provides a means for displaying a plurality of webcam views or video streams in a webinar, which may be displayed on a screen in any order. For example, the methods and systems may provide one, two, three, or four webcam sources when participating in the webinar (only one video stream—live or prerecorded—may be shown at a time). The webcam views may show any number of views corresponding to one or more school officials and one or more users participating in the webinar. In addition, depending on the server, any one of the webcam views may be the product of one or more video streams. In some embodiments, the webcam views or video streams are displayed in a webinar session to both school officials and users. The webcam views may show multiple school officials and multiple users participating in a webinar session (one at a time).

Embodiments of the system and method allow a school to create and manage webinar, email, mail and telephone campaigns using the campaign management tool, with the same flexibility and oversight. Schools may use the student profile filters to manage these contacts and invitations in order to reach specific student demographics (for example, out-of-state students). In creating these campaigns, the schools may calendar them on a master calendar, assign specific representatives to staff them, store and upload relevant documents and videos to be used during a webinar session and monitor the quality, progress and success of sessions, all through this tool. The campaign management tool is unique to the industry.

Embodiments of the system and method allow a school to utilize their student lists and calendar to provide a one-stop source for admissions officers to organize their focus during the recruiting, application and enrollment periods of the year. The student lists are created by the schools from reviewing the student profiles of students who have registered or attended their webinar sessions (or who have opted-in to being contacted by any school, or any school meeting certain user-designated criteria, to contact them). In some embodiments, schools may create one or more candidate lists, each defined by one or more candidates meeting predefined requirements for a given candidate list. In this case, a candidate meeting the predefined requirements may be identified in the webinar or in the campaign management tool by a name or designation characteristic of the candidate list that is displayed in association with the candidate's avatar. Schools may thus create specific lists that may be sorted for use in future campaigns. However, embodiments of the system and method also allow school officials to hold discussions among various departments within the school, as well as presentations and dialogues with other interested stakeholders in the process, including parents, high school counselors and private counselors.

Embodiments of the system and method allow schools to actively manage not only their contacts with prospective students but also their employees and related personnel involved in the recruiting and admissions process.

Embodiments of the system and method also provide a College Fair application, which would be particularly useful for high schools or high school districts whereby high schools or districts will be able to hold on-line college fairs (inviting both colleges and high school students and their parents to participate). Rather than a college holding a webinar session, the fair will allow multiple colleges or specialty schools to present during the same fair, with a student, parent, relative, guardian, counselor, or other person associated with the student being able to move among various college presentation tabs, just like they used to move from table to table at a traditional college fair in a gymnasium. The College Fair application may also be used to assign specific colleges “exclusive” time slots to present to interested students, more like the traditional on-campus college visit. The College Fair may be arranged by high schools or by regions of the country. The College Fair application is very attractive to smaller colleges as it broadens the ability to be seen by students. Colleges may be input into the application via fields such as: type of school (e.g., 2-year, 4-year, public, private, trade, etc.); size of school, geographic region (e.g., Western U.S., Midwestern U.S., etc.), and location of school (e.g., urban, suburban, rural).

The College Fair application provides another example of a system and method for providing effective communication, in this case between colleges and high school constituents (students, their parents, relatives, guardians, counselors, and/or other people associated with the students). The College Fair application may utilize or include any of the webinar system features described above. In one embodiment, the system and method includes: (1) registering one or more colleges or specialty schools to participate in a college fair webinar (or series of webinars) conducted by the high school or high school district; (2) registering one or more users, including prospective students/candidates, parents, relatives, guardians, counselors, and/or other people associated with the candidates, to participate in the webinar; (3) allowing the registered colleges and/or specialty schools to present information about their schools to the users participating in the webinar; and (4) allowing the users to submit questions to any of the colleges or specialty schools participating in the webinar, whereby the questions and answers may be viewed online by one or more participants in the webinar.

In one embodiment, users, including prospective students/candidates, parents, relatives, guardians, counselors, and/or other people associated with the candidates, are provided a means for submitting or displaying profile information to the registered colleges and/or specialty schools. The profile information is preferably obtained prior to the webinar, and may be obtained when registering for the webinar, at some point prior to the webinar. Alternatively, the profile information may be obtained during or after the webinar. Profile information of the student may be displayed during the webinar (e.g., to the schools) together with questions posted by the student or other person associated with the student. The registered colleges and/or specialty schools also may be provided with means to target a user in their campaigns to recruit students based on the profile information or dialogue with a student or person associated with the student during the webinar.

The College Fair application may also provide for the creation of one or more unique widgets on the high school's website, high school district's website or any other website. Participants may schedule their participation in a webinar as a result of registering for the webinar after clicking one or more widgets on such website. By clicking on a widget, for example, a prospective student, parent, relative, guardian, counselor, or other person associated with the student is directed to a page offering the means to register to one or more webinars offered by the high school or high school district. Alternatively, participants may schedule their participation in a webinar as a result of registering for the webinar by simply clicking one or more widgets on such website (i.e., without being subsequently directed to another page).

The College Fair application may include any of the features associated with the above-described webinars, including, but not limited to providing means for Group Chat, Private Chat and Group Questions. Thus, participants may engage in a Group Chat comprising dialogue from video streams and/or audio streams. In addition, users may submit Group Questions and view their answers in the webinar such that the questions and answers may be viewed by one or more of those participating in the webinar or by one or more users viewing the webinar thereafter. The questions are viewed in real-time or remain visible for viewing at a later time during or after the session. Alternatively, users may participate in a Private Chat in which the users submit private questions and view questions and answers that are not displayed to other users participating in the webinar or by one or more users viewing the webinar thereafter. Participants in the webinar may toggle or focus on the screen between Group Chat, Private Chat and Group Questions.

In some embodiments, the registered colleges and/or specialty schools may be allowed to invite a user to a different session, online meeting, telephone conversation, video call/meeting, or in-person meeting based on the profile information of a student (or other person associated with the student) and/or webinar dialogue between the student (or other person associated with the student) and school officials.

The system and method of the College Fair application may similarly provide a means for displaying a plurality of webcam views or video streams in a webinar, which may be displayed sequentially. For example, the methods and systems may provide one, two, three, or four webcam views when participating in the webinar. The webcam views may show any number of views corresponding to one or more school officials and one or more users participating in the webinar. In addition, depending on the server, any one of the webcam views may be the product of one or more video streams. In some embodiments, the webcam views or video streams are displayed in a webinar session to both school officials and users. The webcam views may show multiple school officials and multiple users participating in a webinar session.

Embodiments of the system and method may also be applied to an environment in which a company (or a group of companies) holds job fairs on-line for recruiting employees or for other reasons. The same systems and functions described for use by educational institutions can be used by corporations and other entities.

Specifically regarding communications between a college and prospective students, embodiments of the system and method allow college personnel to talk to a student on a schedule that works for both. In embodiments, the webinar product allows a college to invite prospective students to talk to college personnel and student representatives at all times during the critical choice process, beginning with inquiries, and proceeding through the application, admission and enrollment phases.

In embodiments, the webinar product allows a college to reach students next door, out-of-state and overseas. The ability to live stream videos immediately connects colleges with their audience. The students are given the opportunity to ask questions or talk to the college staff directly. Multiple webinar sessions may be held per month or at other frequencies.

Embodiments of the system and method allow a college to create public and private (invite-only) sessions geared to specific audiences. Embodiments of the system and method allow a college not only to reach students, but also parents, guardians, relatives, and/or counselors, as they proceed through their decision-making process. Invitations may be sent directly by e-mail or other means, such as via telephone, mail, or facsimile, to parents, guardians, relatives, and/or counselors for sessions. Private chat options within a webinar allow a college to connect with a particular student or other participant immediately.

In an embodiment, a widget is placed on a college website or other website, which displays dynamically all or a select number of the available public webinar sessions that the college is offering. The students may immediately see that, by filling out their profile and registering for a session, the students will have an opportunity to communicate directly with the admissions staff and/or current students 103 (FIG. 1). The students are also given the option to limit the distribution of their personal information to only those schools whose webinars they wish to join or which meet other criteria, thus leaving them in control of the process and therefore making them more likely to register.

In an embodiment, webinars may be geared to topics that are relevant at that moment. During the inquiry process, the webinars may be geared to topics that are more general in nature. However, as the application year moves forward, the webinars may become more focused. For example, a webinar may be designed to specifically focus on the parents of out-of-state admittees to address any concerns that they may have about sending their son or daughter to a school.

By connecting with students early in the process, research has shown that students are more likely to keep a school as a potential destination by applying. An increased applicant pool allows a college to choose the best incoming class possible for its institution. Many colleges have started establishing this relationship during a student's freshman or sophomore year in high school. Embodiments of the system and method allow a college to create specific sessions to address the needs of students at all points in this process.

Each year, highly sought after candidates are admitted to a number of schools. They ultimately need to choose one. Embodiments of the system and method may help these candidates choose by gearing the webinars (e.g., during March and April) to topics on their minds. This is especially critical, as many students can no longer afford to make a visit to each campus.

### Communication Tool Description and Advantages.

Embodiments of the system and method for providing effective communication between an entity, e.g., college, and prospective candidates, e.g., students, are designed for the college admissions office or other college officials to be able to have an ongoing dialogue with not only potential applicants during the hectic application period each year, but also with admittees during the spring as the schools attempt to get them to enroll. Embodiments of the system and method provide the personal and interactive communication desired by prospective students. This one-on-one communication from a high school student's perspective is the most desirable contact, based on interviews with students and admissions officers. Embodiments of the system and method provide the students a site that fills their need for access to schools and school personnel, while giving them access to interact with other students either currently attending a college or also participating in the search process.

Embodiments of the system and method provide the structure to allow schools to target the students that they want to communicate with, while allowing the schools to control the message and the messenger (unlike social media sites). This recruitment tool is invaluable to the colleges, especially in times of decreased financial resources where every recruiting/admissions dollar must be spent wisely.

Delivers Prospective Students.

Embodiments of the system and method can deliver the students that the schools are actively seeking, both in terms of qualifications, with its student profile capability, as well as geographically, with its ability to allow schools and students to communicate long-distance but personally. Embodiments of the system and method may be accessible by students through dynamic links on college sites or other websites (also referred to as widgets), as well as the primary application website that utilizes embodiments of the system and method. Embodiments of the system and method may show a student all available webinar sessions. However, to utilize the site fully, a student will have to register, with registration confirmation, and provide the personal information that schools need in order to construct their own campaigns to students. Embodiments of the system and method may allow the schools to manage those campaigns, including campaigns designed specifically for international and out-of-state prospects. Specifically, once a student signs up for a webinar through, for example, a widget, the personal information provided by the student may be forwarded to the college that offers the webinar. The personal information may include the academic profile of the student. The student may also receive campaign messages and other information from the college that is designed specifically for him or her.

Specifically Designed Webinar Functionality.

Unlike webinar tools on the market, an embodiment of the system and method is designed for the college admissions office and other college officials to manage communications with tens of thousands of prospective and current students, while giving the college the tools to drill down effectively, with personalized and focused communications, to those prospective students that they are most interested in.

For example, most colleges will hold “Open Sessions.” These sessions will allow a large number of interested students to attend. Usually, the school will begin the session with the admissions officers or other representative introducing themselves and other presenters and the topic of the presentation session. Pre-recorded videos could be included; documents for students to download would be made available beforehand, during, at the end of the session, and/or after the session. Prior, during, and after the session, the admissions office will have the ability to filter through the prospective students attending the Open Session, allowing them to create and invite the most qualified students to more personal small group or one-on-one dialogues. These subsequent individual or small group sessions, most likely ranging in size from 1 to 50 students, may be set at any size the moderator chooses. Embodiments of the system and method may also give the admissions personnel the tools to reach out and have substantive discussions with specific groups, such as parents and high school counselors.

A student's profile may be simultaneously displayed during a webinar, along with his or her questions. This allows a presenter or facilitator to see the students' pictures and profiles, and to arrange the students' profiles in the order of preference (based on, for example, SAT score, high school, grade level, grades, state of residence, and other considerations). The student profiles may also be filtered. In an embodiment, a facilitator may review each of the students and save a student to a particular list such as a college-created list for future campaigns. Assignment of a student to a list may cause their profile to display a special designation or icon when they participate in future sessions for that college.

In an embodiment, a facilitator of a webinar may manage webinar sessions by limiting the total number of questions that may be asked during the session, limiting the number of questions that may be asked by individual students (e.g., accepting questions from a specific student or a certain group of students based on the students' SAT score, high school, grade level, grades, state of residence, and other considerations (cherry-picking etc.)), and sending an answer to a specific student as opposed to providing public answers.

Embodiments of the system and method provide break-out sessions for a webinar. Generally, these break-out sessions occur during or simultaneously with the main webinar but may occur afterwards. Examples of break-out sessions include a private one-on-one session in which a private chat session may be held (e.g., based on the student's profile); a semi-private session that includes, for example, three or four students; an invite-only webinar in which an embodiment of the system and method filters against a list of students before the webinar begins and only invites a number of students (e.g., out-of-state students) to a semi-private webinar. Sessions may also be arranged in which parents are invited to a webinar; the parents may be invited (e.g., based on their related students' profiles). The system allows students and parents to link their profiles, if desired. Also, a high school counselor webinar may be arranged in which high school counselors are invited based on, for example, the number of interested students in a particular high school.

Embodiments of the system and method provide a campaign management tool so that the admissions office may easily manage and create marketing campaigns. Webinar, telephone, email and regular mail campaigns may be managed. Focused applicant groups may be assigned to specific college personnel, such as student representatives, to provide measurable results. Embodiments of the system and method may record all contacts and activity to make sure that all applicants are properly communicated with and to monitor the effectiveness of the campaigns.

An embodiment of the campaign management tool allows school recruiters to structure webinars to target specific students or groups of students, to determine what filters to apply to locate such students, to structure how email invites are sent out, and to schedule recruiting events. For example, on a certain date, evites may be sent out to all 12th graders. Based on returns, subsequent limited evites may be sent out to a smaller group of students.

Embodiments of the system and method may also allow colleges to highlight departments within the schools with distinctive draws and prestige. These departments may hold their own webinar sessions for students in order to put the school's best foot forward. Prospective students will be able to search for “topic specific” sessions, such as “Journalism.” Embodiments of the system and method may then list all colleges holding sessions regarding Journalism.

Socially Interactive.

Today's students are connected and are heavy users of social media tools such as Facebook, Twitter, blogs, email and texting. Embodiments of the system and method may give the students access to those individuals that mean the most to them in answering their college questions (such as school personnel and current students).
Students want to hear from other high school students thinking of going to the same schools of interest.
Students want to hear from students currently attending their colleges of interest. Other social media provides some of this content; however, with embodiments of the system and method, the colleges felt that it would be highly beneficial that they could control who is speaking on their behalf.

Internal Use.

Embodiments of the system and method may be used by colleges to reach out and manage their communication with prospective students, parents and high school counselors. Embodiments of the system and method may also be used by colleges to communicate to existing students, personnel and faculty. For example, holding financial aid, housing, or Greek rush sessions, for existing students.

Enhances Existing Sites.

Embodiments of the system and method may be personalized, added and linked from any existing college site, allowing such sites to provide an interactive communication environment. Embodiments of the system and method may also be personalized, added and linked from the dozens of existing college search engines. For example, Collegeboard.org is a site where students across the country register for their SAT/PSAT tests. Embodiments of the system and method may also provide several tools to plan for college and to find a college. Embodiments of the system and method may be an excellent complementary feature for that site. This is true for high school sites as well, which could include embodiments of the system and method as a link for their students. It is preferably free for high schools and their students; it may bring the “college fair” experience to them 24/7/365.

The colleges are currently not comfortable with the existing social media tools. Embodiments of the system and method give schools control of which students speak on behalf of their institutions. Conversations may be recorded and reviewed. College personnel are able to hold an open discussion session with a large group of prospective students and may also pull aside a prospective student into a private dialogue to continue with a more focused conversation with a student of interest.

Student Profiles.

Optionally, embodiments of the system and method will ask students to enter certain personal and academic profile information before allowing them full access to participate. The logins may be able to utilize prospective students' existing Facebook or other social network account information for registration, allowing embodiments of the system and method to better match a college with students and permits the colleges to better utilize their time and money by targeting their marketing efforts more effectively.

The site is designed with today's student in mind, utilizing pictures, videos and social media to communicate the information needed, while maintaining a consistent flow on how and what information is displayed.

Those students entering the site without a college selected will be able easily to select colleges that they are most interested in and see the planned webinar schedules. Students may connect to college admission and other officers, students already attending the colleges and other high school students interested in attending the same or other colleges.

### Exemplary Features of Webinar Application.

A web-based application providing internet video, audio and text chat communications between students, parents and high school and private counselors with college admission personnel, department heads and college students. Within the webinar tool, the ability for the moderator to control the flow of chat messages and questions is provided. Existing webinar tools permit the free flowing of chat messaging. It is almost impossible to determine when someone is trying to ask a question or just tracking related comments in the chat discussion. This is unruly when presenting to 500 or more participants. The webinar tool fills this gap. Within the webinar tool, a moderator can, for example:
(A) turn on/off open chat dialog as desired.
(B) turn on/off a questions mode, where users' messages are separated from the regular live chat window and moved to a questions queue that can be worked by several presenters to be answered and presented back to the user in a Question and Answer window.
(C) control the number of questions submitted by all participants. For example, the moderator will say, “I will open the discussion to some questions. We'll be taking the first 20 questions.”
(D) control the number of questions per participant that can be submitted at any given time. “ . . . We'll be taking the first 20 questions and each participant can submit up to 2 questions each.”
(E) stop a participant from submitting chat or questions at any time. For example due to inappropriate behavior.
(F) turn on/off the acceptance of private questions. This allows participants to ask a question for the presenters to answer and which answer can be viewed only by the participant.
(G) A non-presenter can view the participants' profiles and easily save them to custom lists. For example, a college presenter can review the participants' profiles during a college fair presentation and save students to a “favorites”, “top 10%” or any type of list they create.
(H) a non-presenter can initiate a live video/message chat with a participant while the running webinar continues. For example, for a college fair, a college moderator can continue with a video presentation with 100 plus students, while college representatives have private sessions with specific students of interest.

### Exemplary Features of College Fair Application.

The college fair application allows the fair promoters (High School/High School District) to schedule and manage both single or multiple presenters (colleges) and participants (students/parents) at one time within one application.

With the College Fair application, the High School or District administrators select the date and times when they want to hold the college fair. They can either setup an “open” fair, which allows multiple colleges to present at the same time and students jump from booth to booth or the ability to setup an “exclusive” fair, which invites colleges to present at a specific time slot by themselves (giving students the ability not to miss any college presentation). After the High School or District sets the type and date/time of the fair, they click and choose the colleges they want to invite. The College Fair application automatically sends invites within the system to the colleges' dashboards where they can accept or decline the invitations (or propose a different time if they want to meet with that school but the suggested time/date is unavailable). The High School or District can easily track who will be presenting or replace those who declined. Then the system generates invites via email, notifications on the student's dashboard or the school's or district's website via a customizable widget.

### Exemplary Features of Widget Application.

The ability to utilize multiple widgets on websites/pages that dynamically update based on information given by the College Fair or Webinar applications is provided. For example, the college's home page widget can display all webinars available from the college and another widget placed on the college's math department's page could display only math department-related webinars.

### System Components.

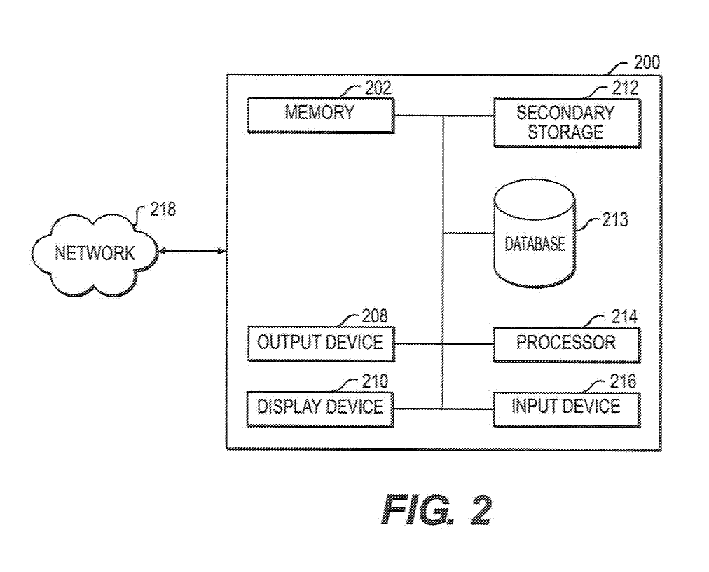

With reference now to FIG. 2, shown is a block diagram illustrating exemplary hardware components for implementing embodiments of the system and method for providing effective two-way communication between an entity and prospective candidates. Server 200, or other computer system similarly configured, may include and execute one or more programs to perform functions described herein, including steps of the method described above. Likewise, a mobile device which includes some of the same components of computer system 200 may perform steps of the method described above. Computer system 200 may connect with network 218, e.g., Internet, or other network, to receive inquires, obtain data, and transmit information and incentives as described above.

Computer system 200 typically includes a memory 202, a secondary storage device 212, database 213, and a processor 214. Server 200 may also include a plurality of processors 214 and be configured as a plurality of, e.g., bladed servers, or other known server configurations. Server 200 may also include an input device 216, a display device 210, and an output device 208. Memory 202 may include RAM or similar types of memory, and it may store one or more applications for execution by processor 214. Secondary storage device 212 may include a hard disk drive, floppy disk drive, CD-ROM drive, or other types of non-volatile data storage. Processor 214 executes the application(s), which are stored in memory 202 or secondary storage 212, or received from the Internet or other network 218. The processing by processor 214 may be implemented in software, such as software modules, for execution by computers or other machines. These applications preferably include instructions executable to perform the functions and methods described above and illustrated in the Figures herein. The applications preferably provide GUIs through which users may view and interact with the application(s).

Also, as noted, processor 214 may execute one or more software applications in order to provide the functions described in this specification, specifically to execute and perform the steps and functions in the methods described above. Such methods and the processing may be implemented in software, such as software modules, for execution by computers or other machines. For example, processor 214 may cause widgets to be displayed on colleges' websites to give the colleges the ability to advertise their webinars. The GUIs may be formatted, for example, as web pages in HyperText Markup Language (HTML), Extensible Markup Language (XML) or in any other suitable form for presentation on a display device depending upon applications used by users to interact with the system for providing effective two-way communication between an entity and prospective candidates.

Input device 216 may include any device for entering information into computer system 200, such as a touch-screen, keyboard, mouse, cursor-control device, microphone, digital camera, video recorder or camcorder. The input device 216 may be used to enter information into GUIs during performance of the methods described above. Display device 210 may include any type of device for presenting visual information such as, for example, a computer monitor or flat-screen display (or mobile device screen). The display device 210 may display the GUIs and/or output from the application(s). Output device 208 may include any type of device for presenting a hard copy of information, such as a printer, and other types of output devices include speakers or any device for providing information in audio form.

Examples of computer system 200 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 200 is shown in detail, embodiments of the system for providing effective two-way communication between an entity and prospective candidates may use multiple computer systems or servers as necessary or desired to support the users and may also use back-up or redundant servers to prevent network downtime in the event of a failure of a particular server. In addition, although computer system 200 is depicted with various components, one skilled in the art will appreciate that computer system 200 may contain additional or different components. In addition, although aspects of an implementation consistent with the above are described as being stored in memory, one skilled in the art will appreciate that these aspects may also be stored on or read from other types of computer program products or computer-readable media, such as secondary storage devices, including hard disks, floppy disks, or CD-ROM; or other forms of RAM or ROM. The computer-readable media may include instructions for controlling a computer system, such as computer system 200, to perform a particular method, such as methods described above.

The managed webinars and college fair webinars of the present invention mentioned throughout this disclosure utilize a website which runs on or operates with a web server, which is executed on, for example, a Windows® operating system, which runs in, for example, a virtual machine, which runs on a virtual machine server provided at a hosting provider.

Functions such as filtering of prospective student profile information utilizes a database 213 which runs off of a database server, which runs on, for example, a Windows® operating system, which runs in, for example, a virtual machine, which runs on a virtual machine server provided at a hosting provider. Filtering is performed, for example, by pulling the record set of data that is supplied by users such as user preferences, profile information, histories of webinar usage, whether a user has registered, been invited to, or attended a webinar. Any of these data may be input into database 213 via, for example, utilization of standard web forms. The record set is filtered by the school (with or without ranking of the results set) in accordance with desired results.

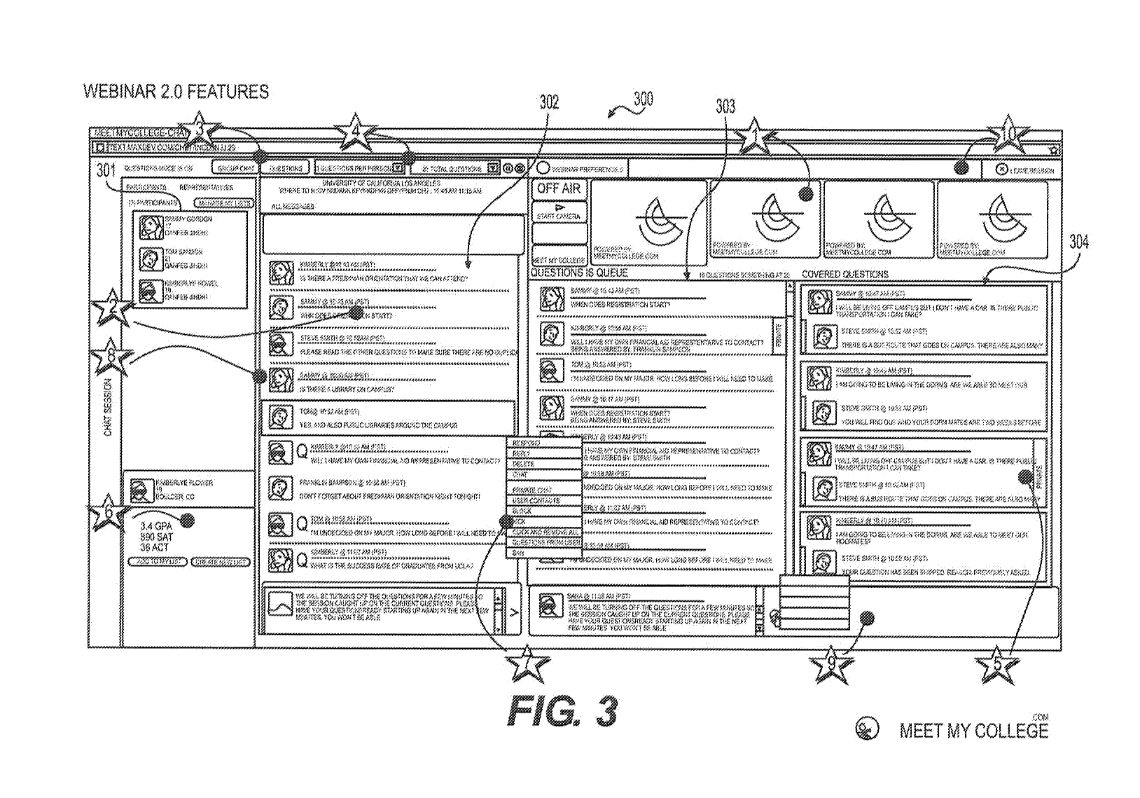

FIG. 3 illustrates an exemplary webinar user interface screen 300, in accordance with certain embodiments of the system and method for providing effective communication between an entity, e.g., college or other school, and users, e.g., prospective candidates, students, parents, relatives, guardians, counselors, etc. FIG. 3 highlights some of the chat session features, including: (1) control of multiple webcams (e.g., four) for presentations during a session; (2) live chat/questions remain visible; (3) easy toggle or focus between Group Chat and Group Questions; questions are easily identified from the chat messages; (4) control of the number of questions submitted and the number of questions per participant; (5) permit students to submit Private questions during Group Chat or Group Questions; (6) quickly view a student's academic profile (or other profile information) by clicking on the student's avatar; (7) block, kick or ban participants; (8) easily add students to a particular favorite list such as “My Lists”; an icon such as a gold star appears on the student's avatar if they are on a My List; (9) quickly skip questions with predefined answers; (10) easily extend a session as needed. Section 301 displays participants of the webinar. In this example, (3) participants of the webinar are shown. Section 302 of the user interface contains a list of the live chat/questions mentioned above. Section 303 of the user interface contains a list of questions that are in queue awaiting a response thereto. Section 304 of the user interface contains a list of questions along with their respective answers/responses thereto.

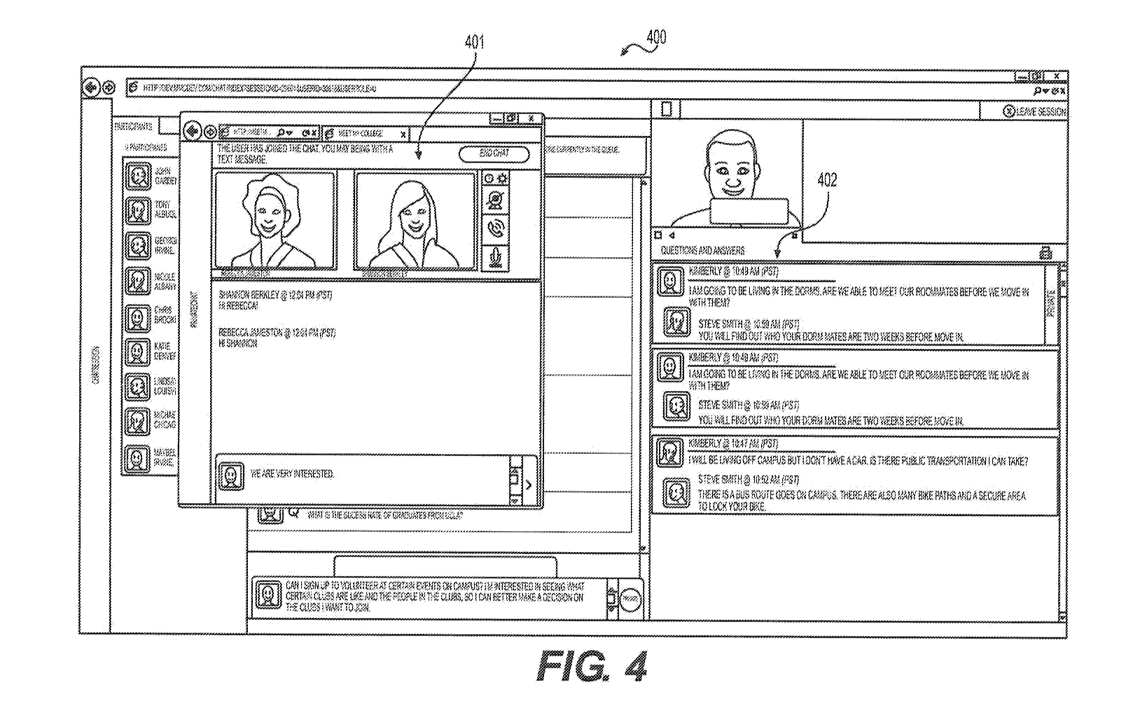

FIG. 4 depicts an exemplary webinar user interface screen 400 illustrating screen features in use during a private chat during an exemplary webinar chat session. Screen section 402 contains a list of questions along with their respective answers/responses thereto. Screen section 401 is preferably a pop-up window of the current private chat preferably between (2) users. Avatars are shown for each individual in the private chat.

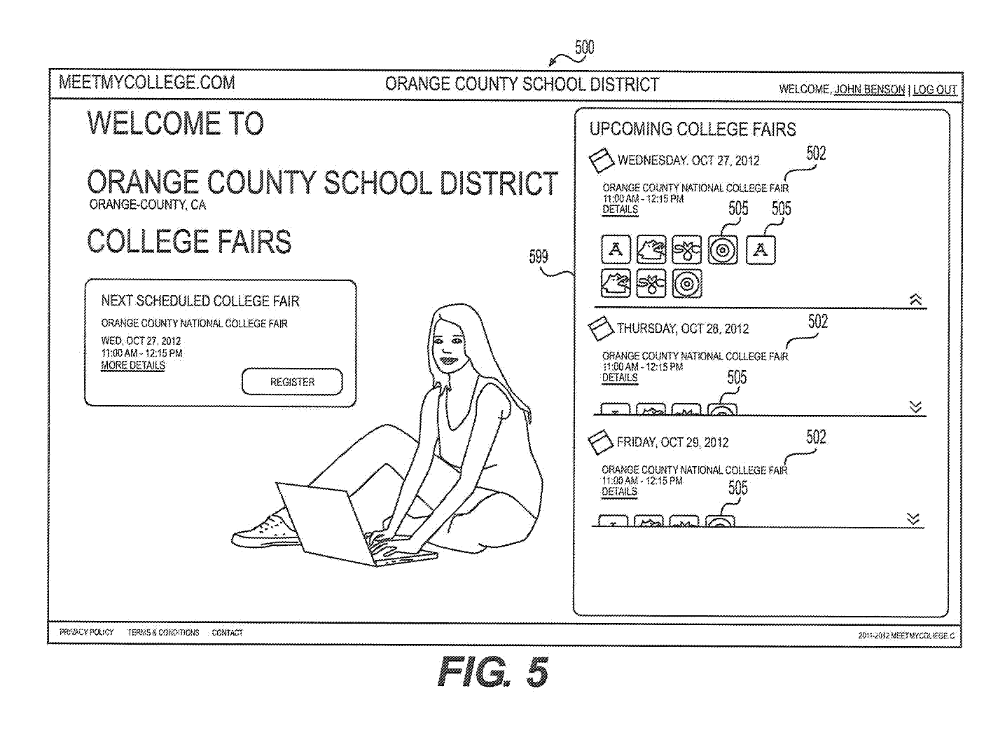

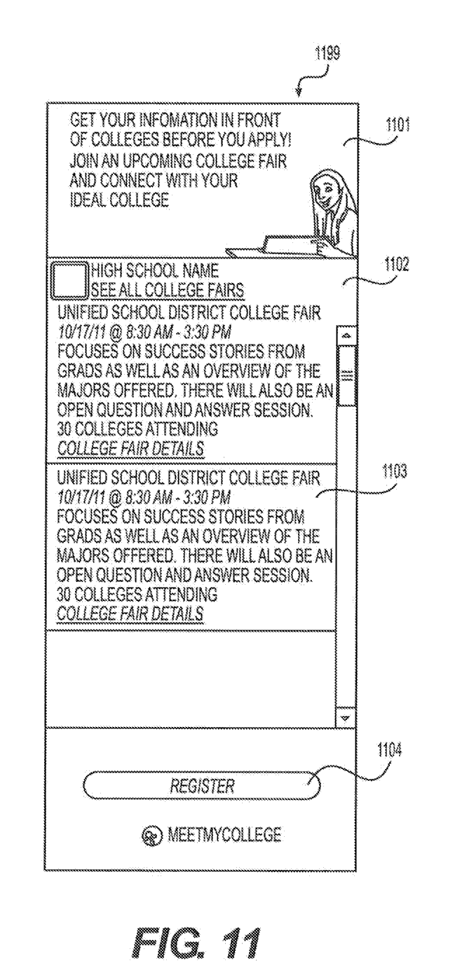

FIG. 5 illustrates an exemplary screenshot 500 from the College Fair application, which depicts a widget 599 listing upcoming college fairs 502, along with icons 505 representing each of the schools attending these fairs. The widget 599 lists available College fair Webinars and is provided for registering users to attend a particular online College Fair webinar held by a high school or high school district. The widget may alternatively reside on any web page, even a web page unrelated to schooling. Another exemplary College Fair widget 1199 is illustrated in FIG. 11. Within a College Fair, each college would have its own webinar running; prospective students and other users may choose which virtual college “table” they wish to visit at a fair. Students and other users may even go back to a “table” previously visited so long as the college is still participating.

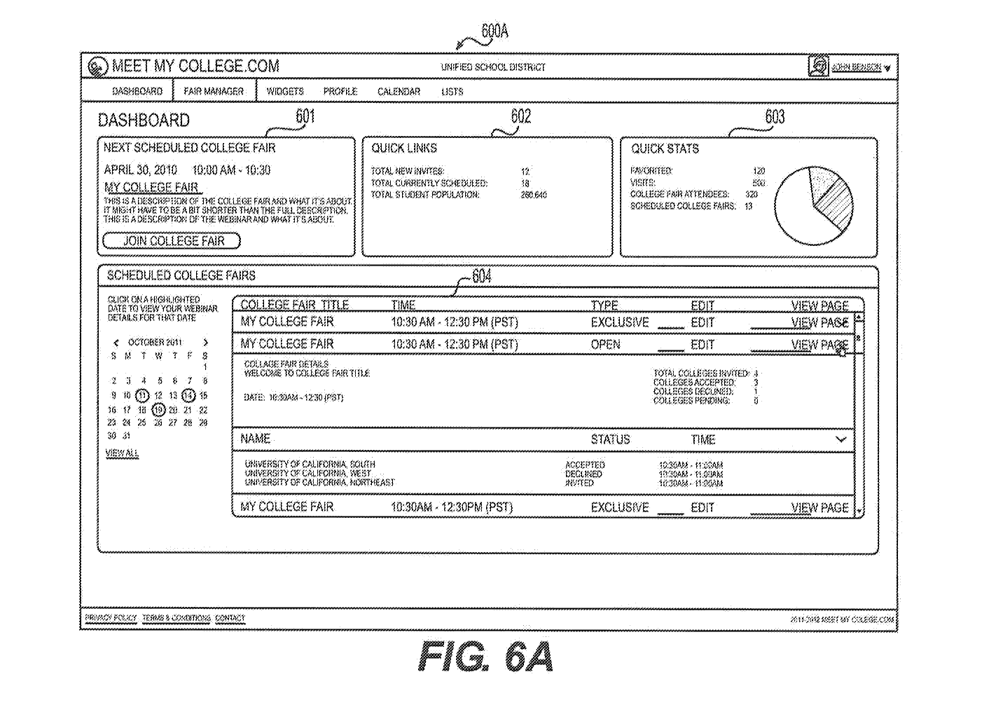

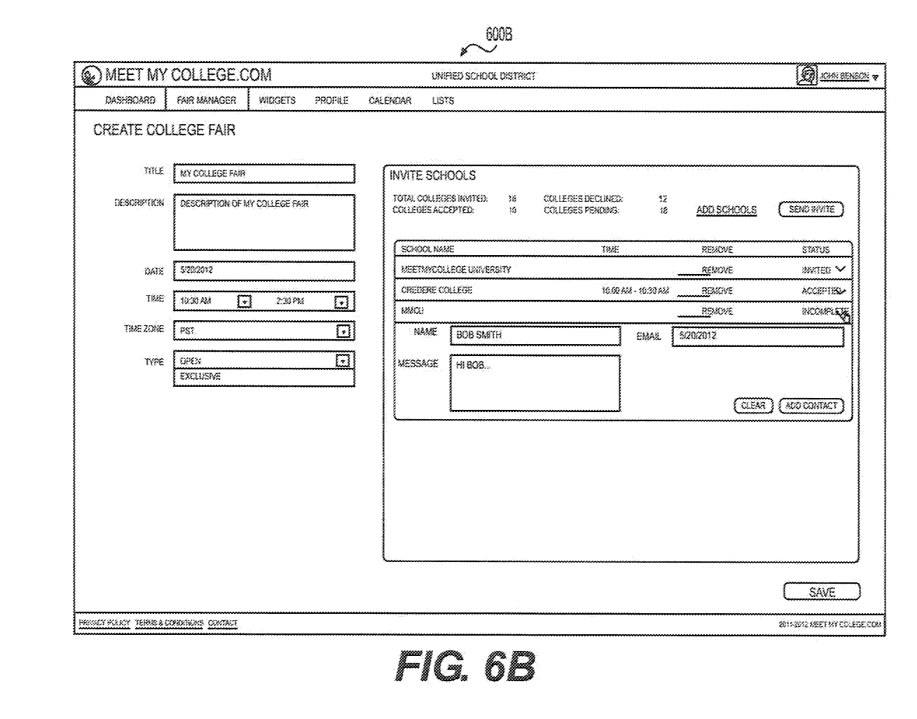

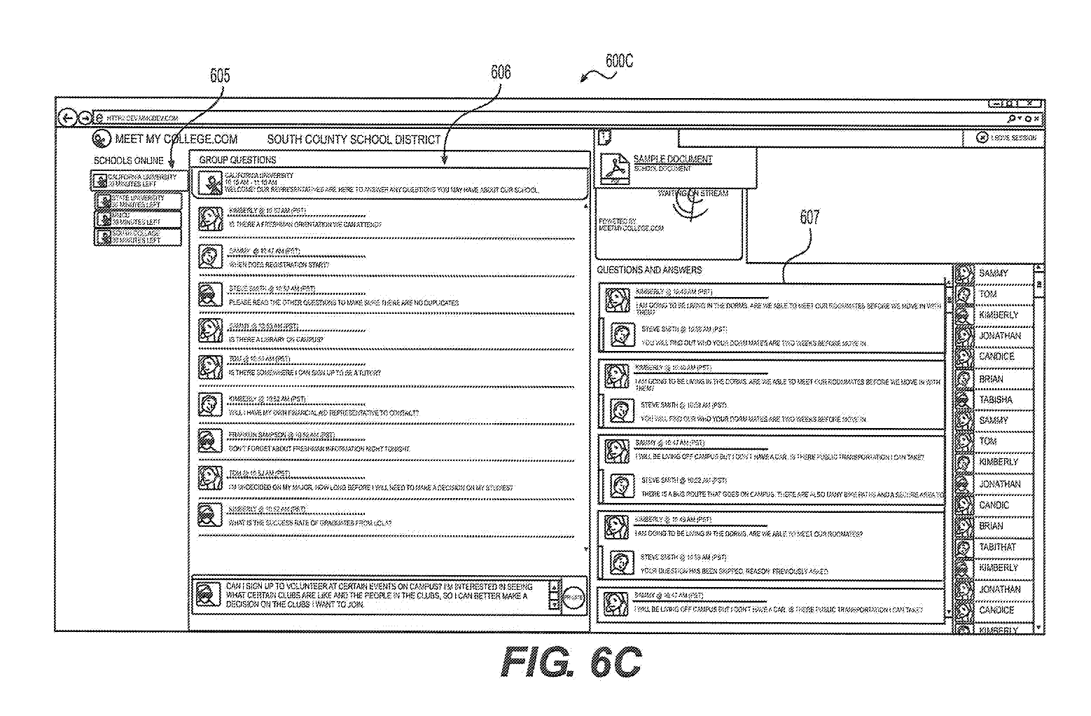

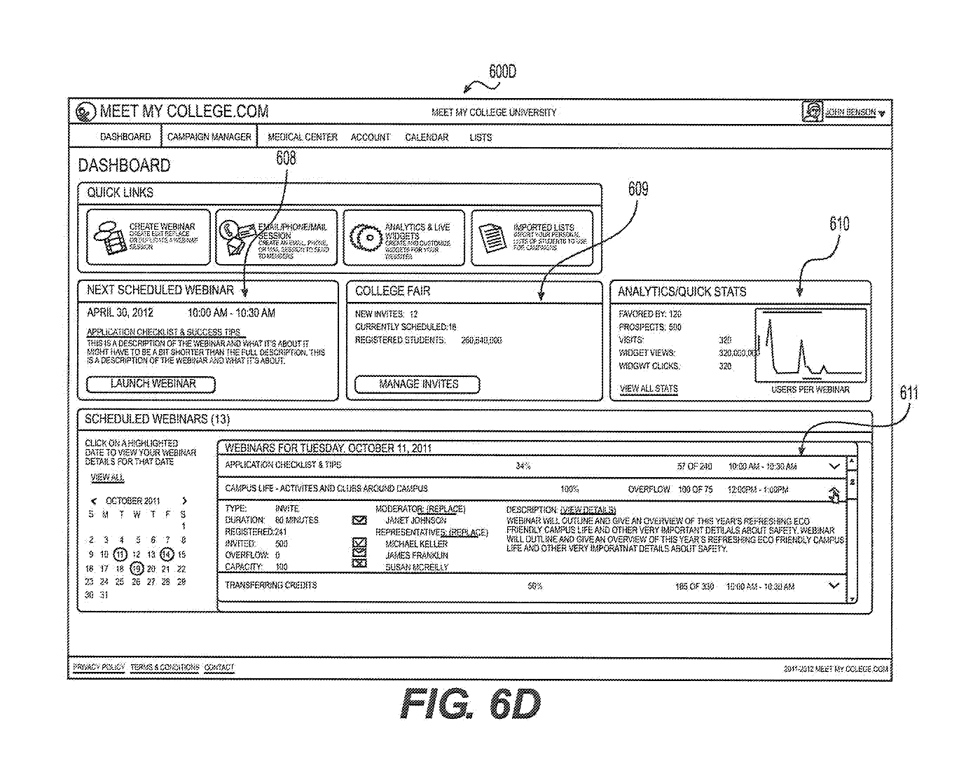

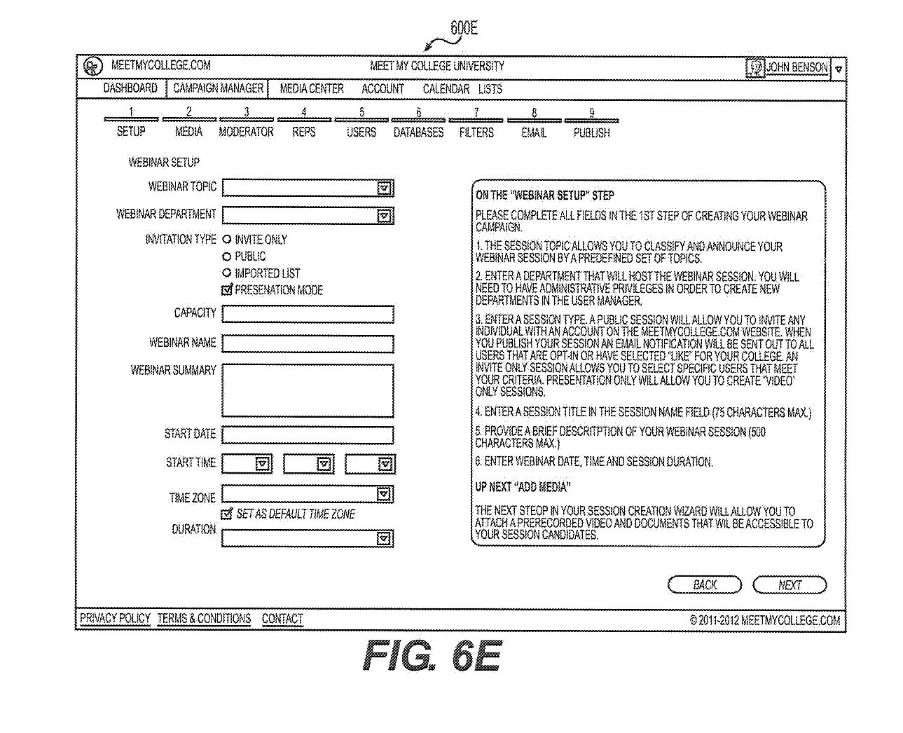

FIGS. 6A-6E illustrate exemplary screenshots 600A-600E, respectively, from the College Fair application and from a webinar session, including pages for school officials to set up and manage a College Fair, webinar or recruitment campaign, pages for managing a user's College Fair and/or webinar scheduling and participation and pages for setting up a profile. In FIG. 6A, section 601 illustrates the next scheduled college fair webinar and the ability to join the college fair webinar. Screen section 602 contain quick links and may display numbers of invites, attendees, scheduled, and total student population. Screen section 603 displays quick statistics such as “Favored”, “Visits”, “College Fair Attendees”, and “Scheduled College Fairs”. Screen section 604 lists the scheduled college fairs, and also their status and types. FIG. 6B's screenshot 600B illustrates steps in creating a college fair webinar. Fields such as Title, Description, Date, Time, and Time Zone are preferably utilized. A screen section for inviting school to the college fair webinar is also depicted. In FIG. 6C's screenshot 600C, section 605 lists schools that are currently online. Screen section 606 contains a list of group questions that are in queue awaiting a response thereto. Screen section 607 contains a list of questions along with their respective answers/responses thereto. In FIG. 6D's screenshot 600D, section 608 lists the next scheduled webinar and the ability to launch the webinar upon depressing of, for example, a “LAUNCH WEBINAR” button. Screen section 609 lists new invites to all webinars, the number of webinars currently scheduled, and the total number of registered students. Section 610 illustrates analytics and/or quick statistics such as number of widget views and/or widget clicks. FIG. 6E's screenshot 600E illustrates steps in setting up a webinar. Fields such as Webinar Topic, Webinar Department, Invitation Type, Capacity, Webinar Name, Webinar Summary, Start Date, Start Time, Time Zone, and Duration are preferably utilized.

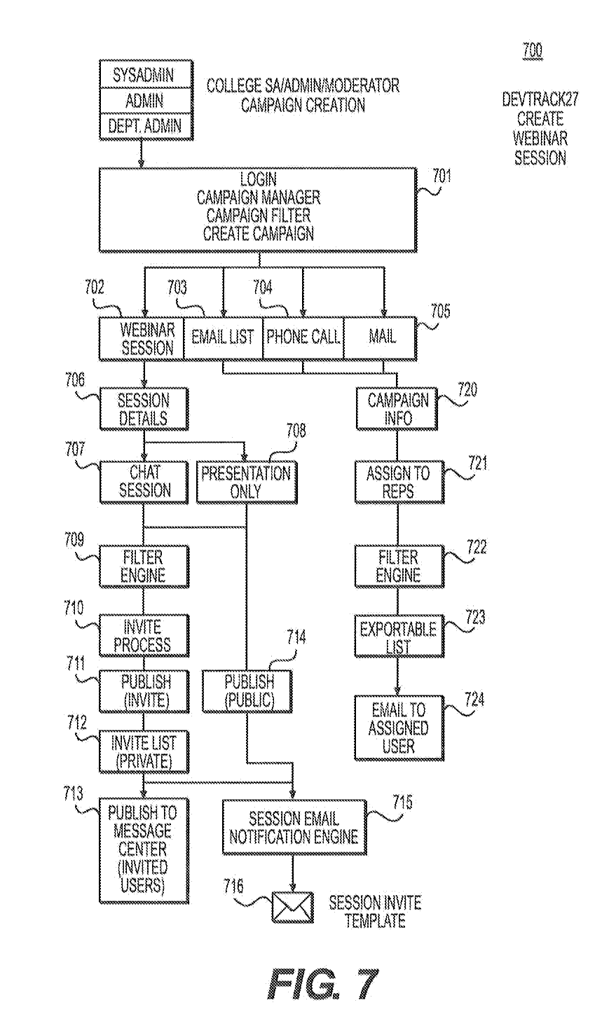

FIG. 7 illustrates an exemplary process flow 700 of an embodiment of a method and system for providing features of a campaign management system. The process flow 700 contains processes for creating a webinar session campaign and includes various steps beginning with the Login Campaign Manager 701. The process for contacting users through a Webinar Session 702 includes the following steps: Session Details 706, Chat Session 707, Presentation Only 708, Filter Engine 709, Invite Process 710, Publish (Invite) 711, Publish (Public) 714, Invite List (Private) 712, Publish to Message Center (Invited Users) 713, Session Email Notification Engine 715 resulting in Session Invite Template 716. The process for contact through as means other than webinar, namely Email List 703, Phone Call 704, or Mail 705, includes the following steps: Campaign Information 720, Assigning to Representatives 721, Filter Engine 722, Exportable List 723, and Email to Assigned User 724.

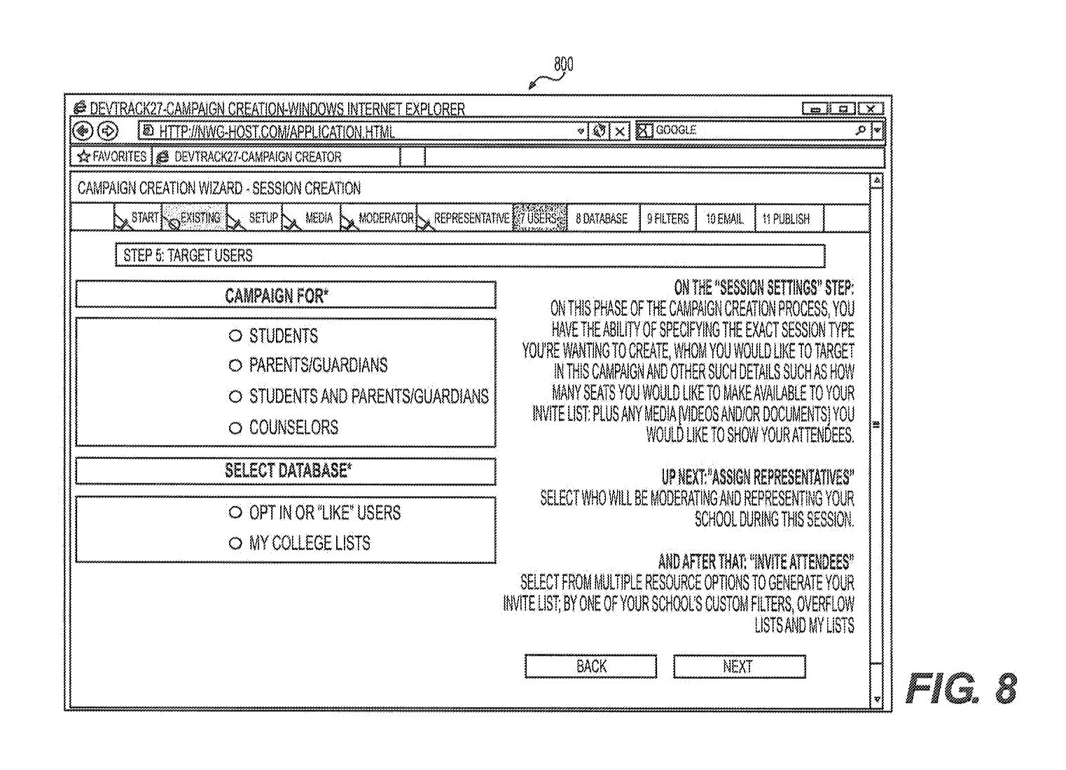

FIG. 8 illustrates an exemplary screenshot 800 of a campaign management tool/Wizard for the campaign management system. The screenshot 800 illustrates a campaign creation wizard and includes a section that displays options for selecting the target of the campaign. The target options depicted are, for example, Students, Parents/Guardians, Students and Parents/Guardians, and Counselors. The choices for selection of a database to utilize is also provided. The database choices are “Opting in or “Liking” Users, or My College Lists. The campaign management system filters prospective student profile information utilizing a database which runs off of a database server, and the filtering comprises pulling at least one record set selected from the group consisting of:

data corresponding to the profile information;

data corresponding to preferences of the users;

data corresponding to webinar histories of the users;

data corresponding to webinars that users have registered for;

data corresponding to webinars that users have been invited to; and

data corresponding to webinars that users have attended.

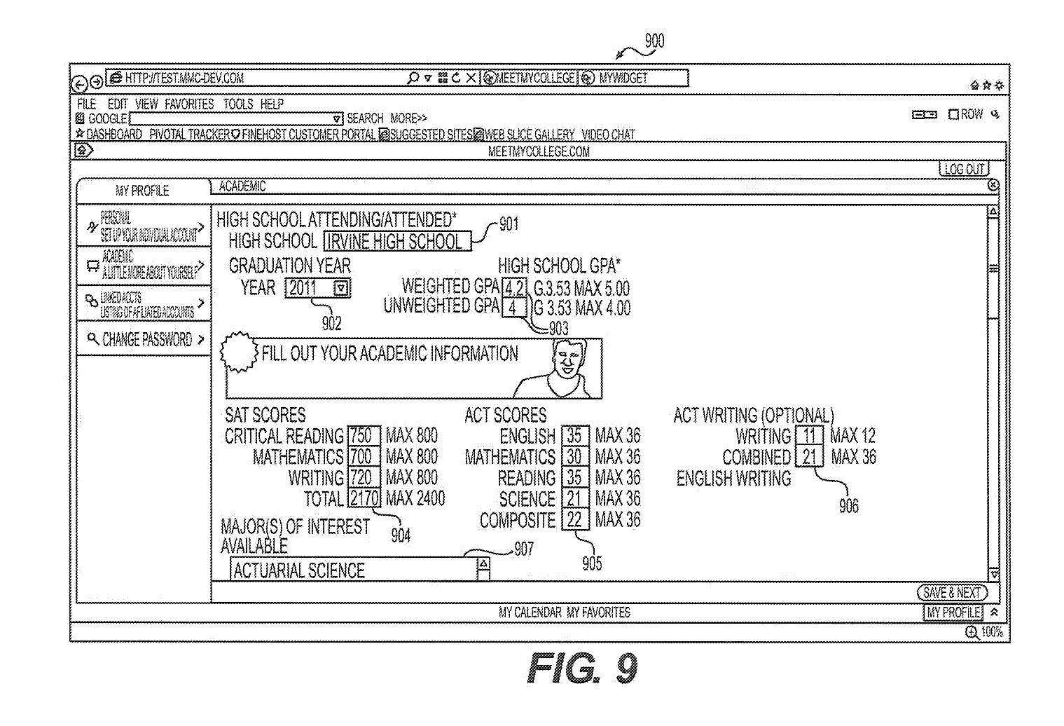

FIG. 9 illustrates an exemplary screenshot 900 of a My Profile user interface screen for student users to input their profile information comprising fields such as high school attending/attended 901, graduation year 902, high school GPA 903, SAT scores 904, ACT scores 905, ACT writing (optional) scores 906, and major(s) of interest 907. This information will be stored as a user profile in a database with other user profiles.

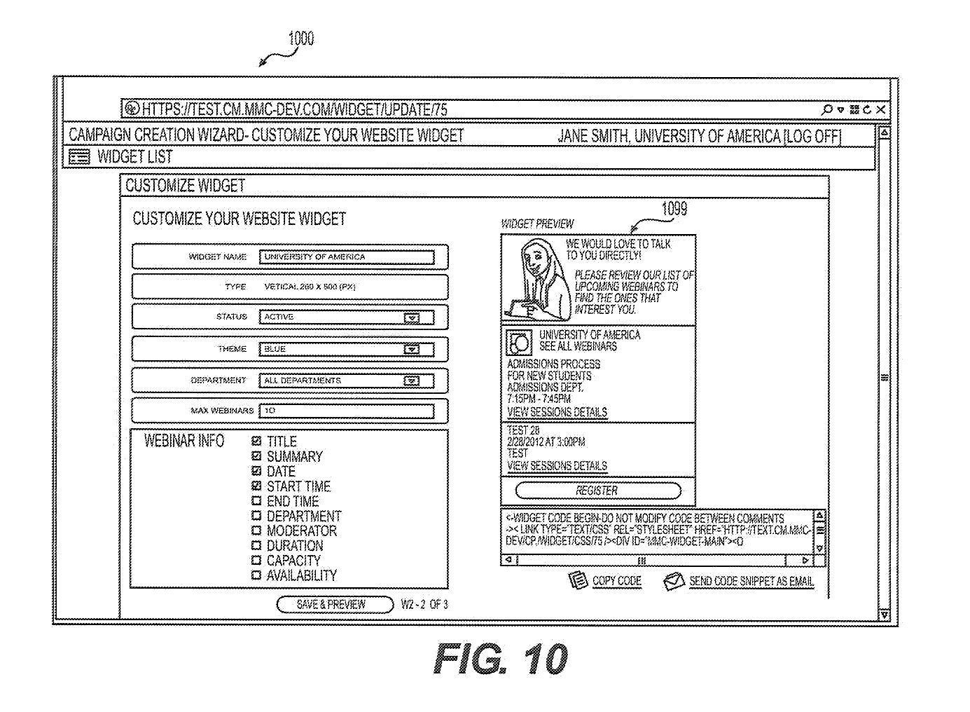

FIG. 10 illustrates an exemplary screenshot 1000 of a user interface screen for creating and customizing a website widget 1099. To customize the widget, exemplary fields such as Widget Name, Type, Status, Theme, Department, Maximum Webinars, and Webinar Information are preferably provided. With this information, the system can create a new widget to be displayed on a website.

FIG. 11 illustrates an exemplary screenshot of a college fair widget 1199. Widget 1199 preferably comprises multiple screen sections. Screen section 1101 displays a header with general information about joining a college fair webinar. Screen sections 1102 and 1103 respectively list upcoming college fair webinars including the particular high school district that is conducting each college fair webinar. The date, time, and description of the upcoming college fair webinars are also shown. A “Register” button 1104 is also provided for a user to “click-on” to register for a college fair webinar.

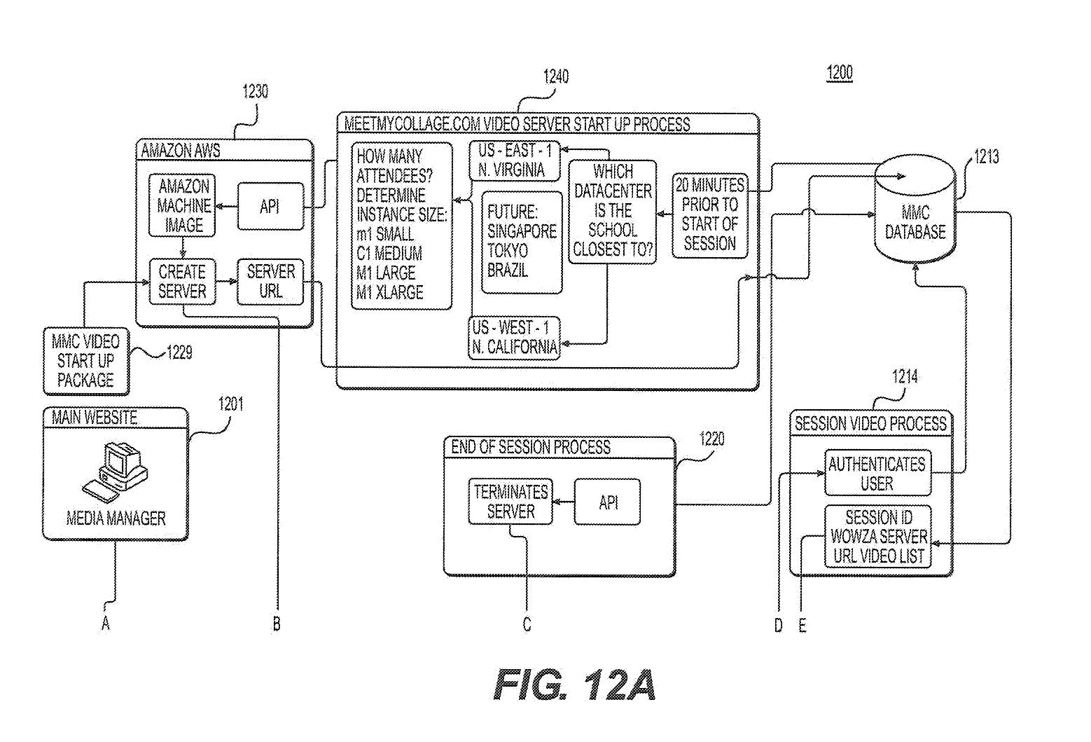

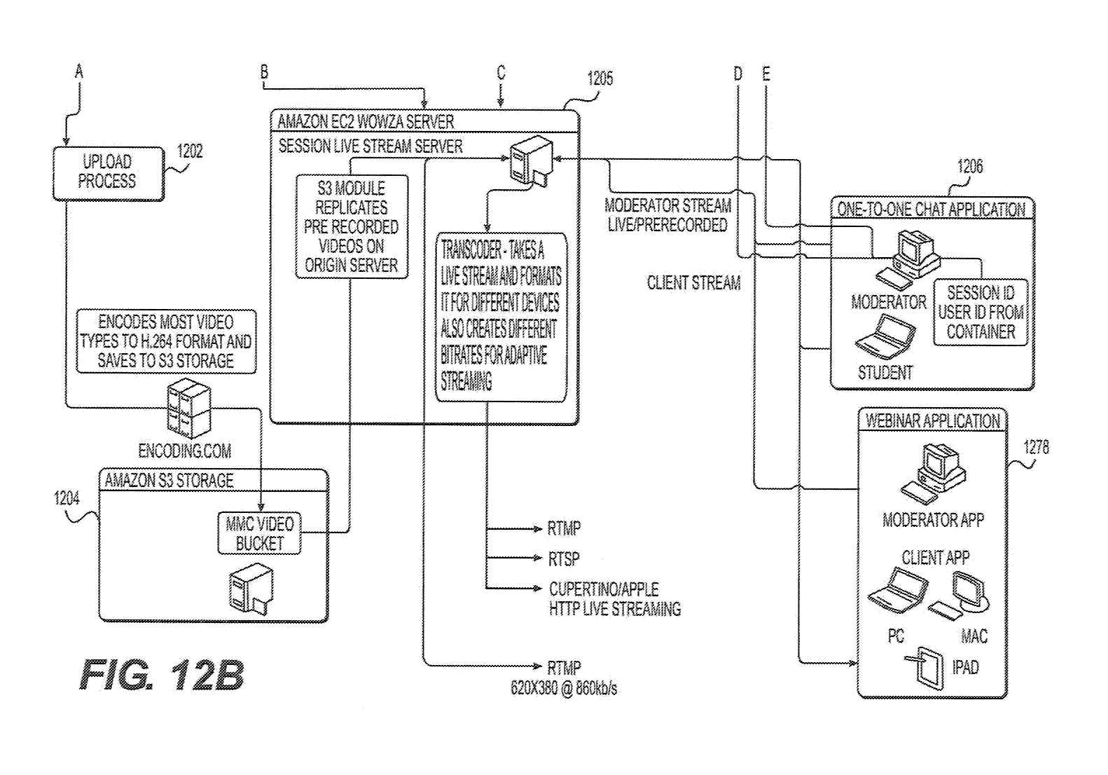

FIGS. 12A and 12B illustrate exemplary hardware components for the video streaming process including video communications flow processes 1200 used in operation of the system. The flow processes 1200 utilize software and components to function. The components include database 1213, video/media server 1205 which is a streaming video/media server, One-To-One Chat Application 1206, Webinar Application 1278, Upload Process 1202, Storage 1204, Server Start Up Process 1240, Main Website 1201, server creation module 1230, Session Video Process 1214, and an End of Session Process 1220. With regards to the video/media server, one example of a suitable server is a Wowza® video/media server. As is depicted in FIGS. 12A and 12B, various hardware components such as desktops, servers, laptops, tablets, and storage devices may be used. These components support a website, one-to-one chat applications, and the webinar applications including pre-recorded or live streaming. Various start-up and set-up processes are typically used in operating the system.

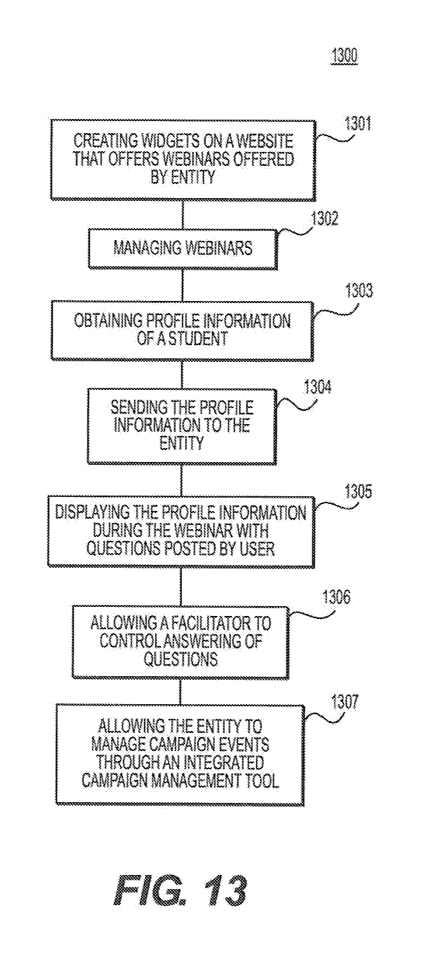

FIG. 13 illustrates an exemplary process flow 1300 of an embodiment of a method and system for providing effective two-way communication between an entity and user.

In any of the embodiments above, the student may be substituted (or joined) by their parent, relative, guardian, counselor, and/or other person associated with the student.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for providing effective communication between an education organization, one or more colleges and/or specialty schools, and one or more users, comprising:
registering one or more colleges and/or specialty schools to participate in an on-line college fair webinar conducted by the education organization;
registering one or more users to participate in the webinar, wherein the one or more users is selected from the group including prospective students, parents, relatives, guardians, counselors and other people associated with the students;
allowing each of the colleges and/or specialty schools to present information about its school to the one or more users in the webinar; and
allowing the one or more users to submit questions to any of the colleges and/or specialty schools in the webinar, wherein the questions and answers from the colleges and/or specialty schools are viewable online by one or more participants in the webinar.

2. The method of claim 1, wherein the one or more users are allowed to submit profile information to the colleges and/or specialty schools.

3. The method of claim 1, wherein the colleges and/or specialty schools are allowed to invite at least one of the one or more users to a different webinar session, online meeting, telephone conversation, video meeting, or in-person meeting based on the profile information of the users or dialogue between the one or more users and the colleges and/or specialty schools.

4. The method of claim 1, wherein the colleges and/or specialty schools are allowed to target at least one of the one or more users in its campaign to recruit the prospective students based on profile information of the prospective students or dialogue between the at least one of the one or more users and the colleges and/or specialty schools.

5. The method of claim 1, wherein the webinar can utilize a plurality of video streams displayed sequentially.

6. The method of claim 1, wherein participants in the webinar engage in a group chat comprising dialogue from video streams and/or audio streams.

7. The method of claim 1, wherein the one or more users submit group questions and view answers thereto in the webinar, wherein the questions and answers are viewable by one or more participants in the webinar or by one or more users viewing the webinar thereafter.

8. The method of claim 7, wherein the questions are viewed in real-time or remain visible for viewing at a later time during or after the webinar session.

9. The method of claim 1, wherein at least one of the one or more users participate in a private chat in which the at least one of the one or more users submits and views questions and answers that are not displayed to other users participating in the webinar or by one or more users viewing the webinar thereafter.

10. The method of claim 1, wherein participants in the webinar can toggle between group chat, private chat and group questions online.

11. The method of claim 1 further comprising:
creating one or more widgets on a website of the high school, high school district or other education organization, wherein clicking on the one or more widgets directs the one or more users to a page that displays the college fair webinar offered by the high school, high school district or other education organization available for registration.

12. The method of claim 1 further comprising:
creating one or more widgets on a website of the high school, high school district or other education organization, wherein clicking on the one or more widgets registers the one or more users for the college fair webinar offered by the high school, high school district or other education organization.

13. A system comprising a web application, implemented using a computing device, employed by an education organization to invite one or more colleges and/or specialty schools to participate in a webinar conducted by the education organization, wherein the computing device comprises memory and one or more processors adapted to:
(a) allow the education organization to facilitate and manage the webinar and to register a user, and one or more colleges and/or specialty schools, for participation in the webinar, wherein the user is a prospective student, parent, relative, guardian, counselor, or other person associated with the prospective student;
(b) allow the one or more colleges and/or specialty schools to present information about their schools to the user via the webinar; and
(c) allow the user to submit questions to the one or more colleges and/or specialty schools, wherein answers to the questions are viewable by one or more participants of the webinar.

14. The system of claim 13, wherein the one or more processors are further adapted to allow the user to submit profile information of the user to the one or more colleges and/or specialty schools.

15. The system of claim 13, wherein the one or more processors are further adapted to allow one of the colleges and/or specialty schools to invite the user to a different webinar session, online meeting, telephone conversation, video meeting, or in-person meeting based on profile information of the user or dialogue involving the user in the webinar.

16. The system of claim 13, wherein the one or more processors are further adapted to allow one of the colleges and/or specialty schools to target the user in its campaign to recruit the student based on profile information of the user or dialogue involving the user in the webinar.

17. The system of claim 13, wherein the one or more processors are further adapted to display a plurality of video streams in the webinar that are displayed sequentially.

18. The system of claim 13, wherein the one or more processors are further adapted to allow the webinar to include a group chat wherein participants engage in a dialogue using video streams and/or audio streams.

19. The system of claim 13, wherein the one or more processors are further adapted to allow users to submit group questions and view answers thereto in the webinar, and wherein the group questions and answers are viewable by one or more participants of the webinar session or by the user viewing the webinar thereafter.

20. The system of claim 19, wherein the questions are viewable in real-time or they remain visible for viewing at a later time during or after the webinar session.

21. The system of claim 13, wherein the one or more processors are further adapted to allow the webinar to include a private chat where the user submits and views questions and answers that are not displayed to other users participating in the webinar.

22. The system of claim 13, wherein the one or more processors are further adapted to allow the webinar to toggle between group chat, private chat and group questions.

23. The system of claim 13, wherein the one or more processors are further adapted to create one or more widgets on a website of the education organization, wherein clicking on the one or more widgets directs the user to a page that displays the webinar offered by the education organization available for registration.

24. The system of claim 13, wherein the one or more processors are further adapted to create one or more widgets on a website of the education organization, wherein clicking on the one or more widgets registers the user for the webinar offered by the education organization.
